(19) United States
(12) Patent Application Publication
(10) Pub. No.: US 2017/0347094 A1
(43) Pub. Date: Nov. 30, 2017

(54) BLOCK SIZE ADAPTIVE DIRECTIONAL INTRA PREDICTION

(71) Applicant: GOOGLE INC., Mountain View, CA (US)

(72) Inventors: Hui Su, College Park, MD (US); Yaowu Xu, Saratoga, CA (US); Jingning Han, Santa Clara, CA (US)

(73) Assignee: GOOGLE INC., Mountain View, CA (US)

(21) Appl. No.: 15/168,673

(22) Filed: May 31, 2016

(51) Int. Cl. H04N 19/11; H04N 19/44; H04N 19/182; H04N 19/593; H04N 19/176

(52) U.S. Cl. CPC H04N 19/11; H04N 19/593; H04N 19/176; H04N 19/182; H04N 19/44

(57) ABSTRACT

Using directional intra prediction modes for encoding and decoding a video stream is described. A method includes identifying, peripheral to a current block of a frame of the video stream, a set of previously coded pixels in the frame, identifying a candidate set of directional intra prediction modes from a plurality of directional intra prediction modes based on a size of the current block, and selecting, for the current block, an optimal intra prediction mode from the candidate set of directional intra prediction modes. The optimal intra prediction mode is used to predict the current block based on the set of previously coded pixels.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission or storage of the video data. Various approaches have been proposed to reduce the amount of data in video streams, including compression and other encoding techniques.

### SUMMARY

This disclosure relates generally to encoding and decoding video data and more particularly relates to video coding using directional intra prediction mode. One method for encoding a video stream described herein includes identifying, peripheral to a current block of a frame of the video stream, a set of previously coded pixels in the frame; identifying a candidate set of directional intra prediction modes from a plurality of directional intra prediction modes based on a size of the current block; and selecting, for the current block using a processor, an optimal intra prediction mode from the candidate set of directional intra prediction modes, wherein the optimal intra prediction mode is used to predict the current block based on the set of previously coded pixels.

Another method described herein is a method for decoding an encoded video bitstream including identifying, peripheral to a current block of a frame of the video stream, a set of previously decoded pixels in the frame; identifying a candidate set of directional intra prediction modes from a plurality of directional intra prediction modes based on a size of the current block; and determining, using a processor, an intra prediction mode previously selected for encoding the current block in the video stream, from the candidate set of directional intra prediction modes, wherein the intra prediction mode is used to predict the current block based on the set of previously decoded pixels.

An example of an apparatus for decoding a video stream described herein includes a memory and a processor. The processor is configured to execute instructions stored in the memory to identify, peripheral to a current block of a frame of the video stream, a set of previously decoded pixels in the frame; identify a candidate set of directional intra prediction modes from a plurality of directional intra prediction modes based on a size of the current block; and determine an intra prediction mode previously selected for encoding the current block in the video stream, from the candidate set of directional intra prediction modes, wherein the intra prediction mode is used to predict the current block based on the set of previously decoded pixels.

Variations in these and other aspects of the disclosure will be described in additional detail hereafter.

### BRIEF DESCRIPTION OF THE DRAWINGS

The description herein makes reference to the accompanying drawings wherein like reference numerals refer to like parts throughout the several views.

FIG. 1 is a schematic of a video encoding and decoding system in accordance with implementations of this disclosure.

FIG. 2 is a diagram of an example video stream to be encoded and decoded in accordance with implementations of this disclosure.

FIG. 3 is a block diagram of an encoder in accordance with implementations of this disclosure.

FIG. 4 is a block diagram of a decoder in accordance with implementations of this disclosure.

FIG. 5 is a flow diagram of an example process for encoding a video stream using directional intra prediction modes in accordance with implementations of this disclosure.

FIG. 6 is a diagram showing a 90 degree directional intra prediction mode that may be used in implementations of the teachings herein.

FIG. 7 is a diagram showing a 135 degree directional intra prediction mode that may be used in implementations of the teachings herein.

FIG. 8 is a diagram showing a 90 degree directional intra prediction mode that may be used in implementations of the teachings herein.

FIG. 9 is a diagram showing an 84 degree directional intra prediction mode that may be used in implementations of the teachings herein.

FIG. 10 is a flow diagram of an example process for decoding an encoded video stream using directional intra prediction modes in accordance with implementations of this disclosure.

FIG. 11 is a diagram showing an example implementation of a lookup table for directional intra prediction modes that may be used in implementations of the teachings herein.

FIG. 12 is a diagram showing an example implementation of a lookup table for directional intra prediction modes that may be used in implementations of the teachings herein.

### DETAILED DESCRIPTION

Compression schemes related to coding video streams may include breaking each image into blocks and generating a digital video output bitstream using one or more techniques to limit the information included in the output. A received bitstream can be decoded to re-create the blocks and the source images from the limited information. Encoding a video stream, or a portion thereof, such as a frame or a block, can include using temporal and spatial similarities in the video stream to improve coding efficiency. For example, a current block of a video stream may be encoded based on a previously encoded block in the video stream by predicting motion and color information for the current block based on the previously encoded block and identifying a difference (residual) between the predicted values and the current block.

Intra prediction can include using video data that has been previously encoded and reconstructed to predict the current block in the same frame. The predicted block is deducted from the current block and the difference, i.e., the residual, can be transformed, quantized and entropy encoded to be included in a compressed video stream. In codec schemes such as ones that use raster scan coding, video data above and to the left of the current block have been previously coded (i.e., coded prior to the current block) and are available for use during intra prediction of the current block.

Codecs may support many different intra prediction modes. Intra prediction modes can include, for example, a horizontal intra prediction mode, a vertical intra prediction mode, and various other directional intra prediction modes, also referred to as angular (intra) prediction modes. A directional (angular) intra prediction mode uses a certain angle, often offset from the horizontal or vertical, for predicting along a direction specified by the angle. Each block can use one of the intra prediction modes to obtain a prediction block that is most similar to the block to minimize the information to be encoded in the residual so as to re-create the block. The directional intra prediction modes, as well as other prediction modes, can be encoded and transmitted so that a decoder can use the same prediction mode(s) to form prediction blocks in the decoding and reconstruction process.

Various directional intra prediction modes can be used to propagate pixel values from previously coded blocks along an angular line, that is, in directions offset from the horizontal and/or the vertical, to predict a block. For example, pixel values being propagated can include peripheral pixels above and/or to the left of the block in the same frame. In implementations of this disclosure, a variable and adaptable number of candidate directional intra prediction modes are considered by a block based on the block size. For example, fewer angles can be used for smaller blocks and more angles can be used for larger blocks, because the differences between predictions using a large number of different angles can be less significant for smaller blocks. When a fewer number of candidate directional intra prediction modes is considered for the smaller blocks, fewer bits need to be used to code the prediction modes for these blocks, and the overall coding efficiency is improved. Therefore, by varying the number of candidate directional intra prediction modes based on the block size, the total number of bits to be included to signal the directional intra prediction modes can be reduced for the encoded video bitstream, and the overall compression performance can be improved. Other details are described below after first describing an environment in which the disclosure may be implemented.

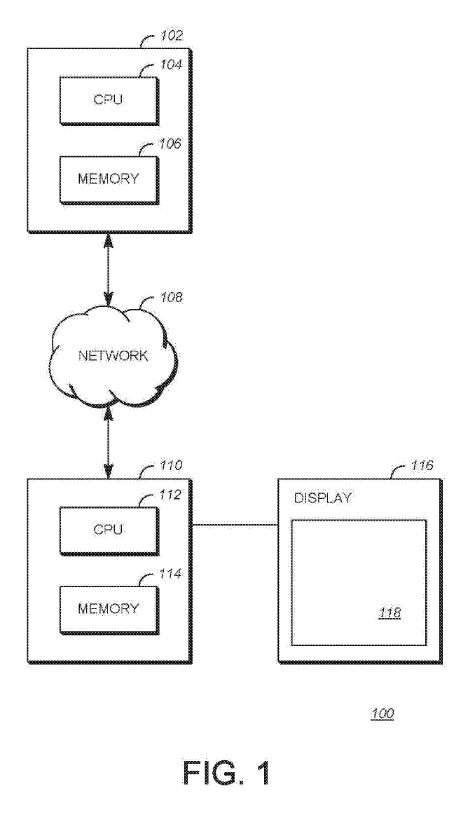

FIG. 1 is a schematic of a video encoding and decoding system 100 in which aspects of the disclosure can be implemented. An exemplary transmitting station 102 can be, for example, a computer having an internal configuration of hardware including a processor such as a central processing unit (CPU) 104 and a memory 106. The CPU 104 is a controller for controlling the operations of the transmitting station 102. The CPU 104 can be connected to the memory 106 by, for example, a memory bus. The memory 106 can be read only memory (ROM), random access memory (RAM) or any other suitable memory device. The memory 106 can store data and program instructions that are used by the CPU 104. Other suitable implementations of the transmitting station 102 are possible. For example, the processing of the transmitting station 102 can be distributed among multiple devices.

A network 108 connects the transmitting station 102 and a receiving station 110 for encoding and decoding of the video stream. Specifically, the video stream can be encoded in the transmitting station 102 and the encoded video stream can be decoded in the receiving station 110. The network 108 can be, for example, the Internet. The network 108 can also be a local area network (LAN), wide area network (WAN), virtual private network (VPN), a cellular telephone network or any other means of transferring the video stream from the transmitting station 102 to, in this example, the receiving station 110.

The receiving station 110 can, in one example, be a computer having an internal configuration of hardware including a processor such as a CPU 112 and a memory 114. The CPU 112 is a controller for controlling the operations of the receiving station 110. The CPU 112 can be connected to memory 114 by, for example, a memory bus. Memory 114 can be ROM, RAM or any other suitable memory device. The memory 114 can store data and program instructions that are used by the CPU 112. Other suitable implementations of the receiving station 110 are possible. For example, the processing of the receiving station 110 can be distributed among multiple devices.

A display 116 configured to display a video stream can be connected to the receiving station 110. The display 116 can be implemented in various ways, including by a liquid crystal display (LCD), a cathode-ray tube (CRT), or a light emitting diode display (LED), such as an organic LED (OLED) display. The 116 is coupled to the CPU 112 and can be configured to display a rendering 118 of the video stream decoded in the receiving station 110.

Other implementations of the encoder and decoder system 100 are also possible. For example, one implementation can omit the network 108 and/or the display 116. In another implementation, a video stream can be encoded and then stored for transmission at a later time by the receiving station 110 or any other device having memory. In one implementation, the receiving station 110 receives (e.g., via the network 108, a computer bus, or some communication pathway) the encoded video stream and stores the video stream for later decoding. In another implementation, additional components can be added to the encoder and decoder system 100. For example, a display or a video camera can be attached to the transmitting station 102 to capture the video stream to be encoded.

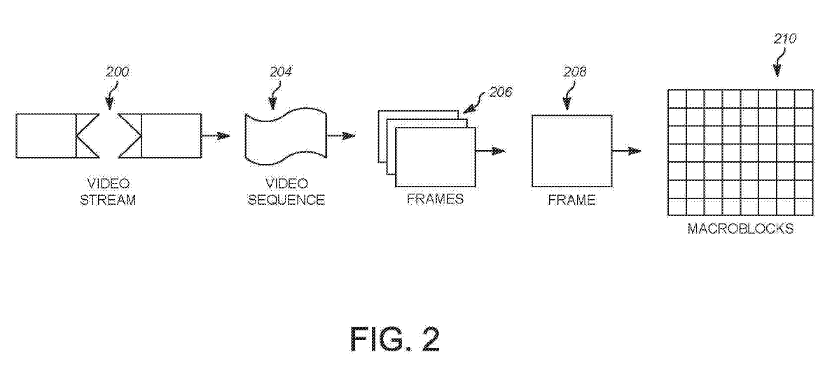

FIG. 2 is a diagram of an example video stream 200 to be encoded and decoded. The video stream 200 (also referred to herein as video data) includes a video sequence 204. At the next level, the video sequence 204 includes a number of adjacent frames 206. While three frames are depicted in the adjacent frames 206, the video sequence 204 can include any number of adjacent frames. The adjacent frames 206 can then be further subdivided into individual frames, e.g., a frame 208. Each frame 208 can capture a scene with one or more objects, such as people, background elements, graphics, text, a blank wall, or any other information.

At the next level, the frame 208 can be divided into a set of blocks 210, which can contain data corresponding to, in some of the examples described below, an 8×8 pixel group in the frame 208. A block 210 can also be of any other suitable size such as a block of 16×8 pixels, a block of 8×8 pixels, a block of 16×16 pixels, a block of 4×4 pixels, or of any other size. Unless otherwise noted, the term ‘block’ can include a macroblock, a subblock (i.e., a subdivision of a macroblock), a segment, a slice, a residual block or any other portion of a frame. A frame, a block, a pixel, or a combination thereof can include display information, such as luminance information, chrominance information, or any other information that can be used to store, modify, communicate, or display the video stream or a portion thereof.

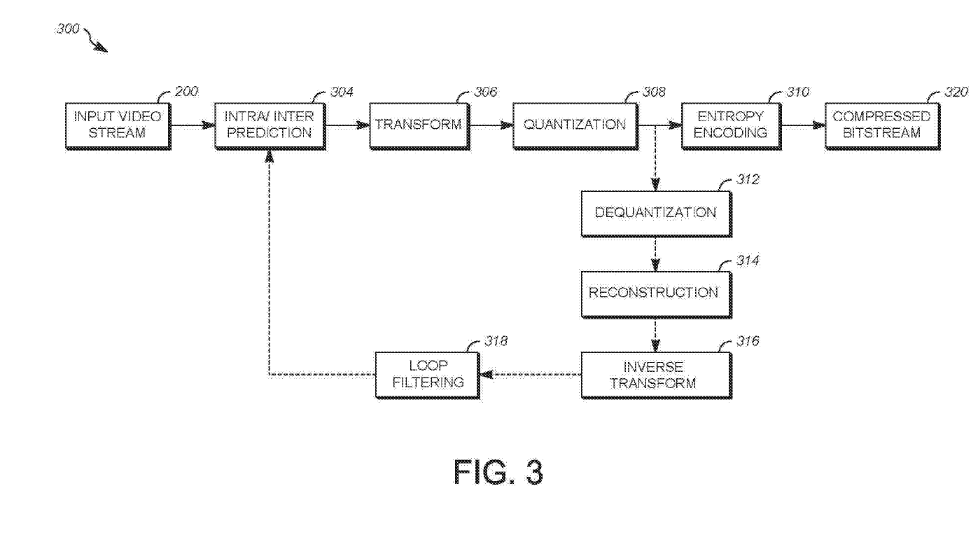

FIG. 3 is a block diagram of an encoder 300 in accordance with implementations of this disclosure. The encoder 300 can be implemented, as described above, in the transmitting station 102 such as by providing a computer software program stored in the memory 106, for example. The computer software program can include machine instructions that, when executed by the CPU 104, cause the transmitting station 102 to encode video data in the manner described in FIG. 3. The encoder 300 can also be implemented as specialized hardware in, for example, the transmitting station 102. The encoder 300 has the following stages to perform the various functions in a forward path (shown by the solid connection lines) to produce an encoded or a compressed bitstream 320 using the video stream 200 as input: an intra/inter prediction stage 304, a transform stage 306, a quantization stage 308, and an entropy encoding stage 310. Encoder 300 may include a reconstruction path (shown by the dotted connection lines) to reconstruct a frame for encoding of future blocks. In FIG. 3, the encoder 300 has the following stages to perform the various functions in the reconstruction path: a dequantization stage 312, an inverse transform stage 314, a reconstruction stage 316, and a loop filtering stage 318. Other structural variations of the encoder 300 can be used to encode the video stream 200.

When the video stream 200 is presented for encoding, a frame 208 within video stream 200 can be processed in units of blocks. Referring to FIG. 3, at the intra/inter prediction stage 304, a block can be encoded using either intra prediction (i.e., within a single frame) or inter prediction (i.e. from frame to frame). In either case, a prediction block can be formed. The prediction block is then subtracted from the block to produce a residual block (also referred to herein as residual).

Intra prediction (also referred to herein as intra-prediction or intra-frame prediction) and inter prediction (also referred to herein as inter-prediction or inter-frame prediction) are techniques used in modern image/video compression schemes. In the case of intra-prediction, a prediction block can be formed from samples in the current frame that have been previously encoded and reconstructed. In the case of inter-prediction, a prediction block can be formed from samples in one or more previously constructed reference frames, such as the last frame (i.e., the adjacent frame immediately before the current frame), a golden frame or a constructed or alternate frame.

The prediction block is then subtracted from the current block. The difference, or residual, is then encoded and transmitted to decoders. Image or video codecs may support many different intra and inter prediction modes; each block may use one of the prediction modes to obtain a prediction block that is most similar to the block to minimize the information to be encoded in the residual so as to re-create the block. The prediction mode for each block of transform coefficients can also be encoded and transmitted so a decoder can use the same prediction mode(s) to form prediction blocks in the decoding and reconstruction process.

The prediction mode may be selected from one of multiple intra-prediction modes. The multiple intra-prediction modes can include, for example, horizontal intra prediction mode, vertical intra prediction mode, and various other directional intra prediction modes, also referred to as angular intra prediction modes, according to implementations of this disclosure. In one implementation of horizontal intra prediction, each column of a current block can be filled with a copy of a column to the left of the current block. In one implementation of vertical intra prediction, each row of a current block can be filled with a copy of a row above the current block. Various directional intra prediction modes propagate, for example, average pixel values from peripheral pixels in blocks above and/or to the left of the current block along an angular line, that is, in directions offset from both the horizontal and the vertical, to form the prediction block.

Alternatively, the prediction mode may be selected from one of multiple inter-prediction modes using one or more reference frames including, for example, last frame, golden frame, alternative reference frame, or any other reference frame in an encoding scheme. The bitstream syntax supports three categories of inter prediction modes. The inter prediction modes can include, for example, a mode (sometimes called ZERO_MV mode) in which a block from the same location within a reference frame as the current block is used as the prediction block; a mode (sometimes called a NEW_MV mode) in which a motion vector is transmitted to indicate the location of a block within a reference frame to be used as the prediction block relative to the current block; or a mode (sometimes called a REF_MV mode comprising NEAR_MV or NEAREST_MV mode) in which no motion vector is transmitted and the current block uses the last or second-to-last non-zero motion vector used by neighboring, previously coded blocks to generate the prediction block. Inter-prediction modes may be used with any of the available reference frames.

Next, still referring to FIG. 3, the transform stage 306 transforms the residual into a block of transform coefficients in, for example, the frequency domain. Examples of block-based transforms include the Karhunen-Loève Transform (KLT), the Discrete Cosine Transform (DCT), Walsh-Hadamard Transform (WHT), the Singular Value Decomposition Transform (SVD), and the Asymmetric Discrete Sine Transform (ADST). In an example, the DCT transforms the block into the frequency domain. In the case of DCT, the transform coefficient values are based on spatial frequency, with the lowest frequency (e.g., DC) coefficient at the top-left of the matrix and the highest frequency coefficient at the bottom-right of the matrix.

The quantization stage 308 converts the block of transform coefficients into discrete quantum values, which are referred to as quantized transform coefficients, using a quantizer value or quantization level. The quantized transform coefficients are then entropy encoded by the entropy encoding stage 310. The entropy-encoded coefficients, together with other information used to decode the block, which can include for example the type of prediction used, motion vectors and quantization value, are then output to the compressed bitstream 320. The compressed bitstream 320 can be formatted using various techniques, such as variable length encoding (VLC) and arithmetic coding. The compressed bitstream 320 can also be referred to as an encoded video stream and the terms will be used interchangeably herein.

The reconstruction path in FIG. 3 (shown by the dotted connection lines) can be used to provide both the encoder 300 and a decoder 400 (described below) with the same reference frames to decode the compressed bitstream 320. The reconstruction path performs functions that are similar to functions that take place during the decoding process that are discussed in more detail below, including dequantizing the quantized transform coefficients at the dequantization stage 312 to generate dequantized transform coefficients and inverse transforming the dequantized transform coefficients at the inverse transform stage 314 to produce a derivative residual block (i.e., derivative residual). At the reconstruction stage 316, the prediction block that was predicted at the intra/inter prediction stage 304 can be added to the derivative residual to create a reconstructed block. In some implementations, the loop filtering stage 318 can be applied to the reconstructed block to reduce distortion such as blocking artifacts.

Other variations of the encoder 300 can be used. For example, a non-transform based encoder can quantize the residual block directly without the transform stage 306. In another implementation, an encoder can have the quantization stage 308 and the dequantization stage 312 combined into a single stage.

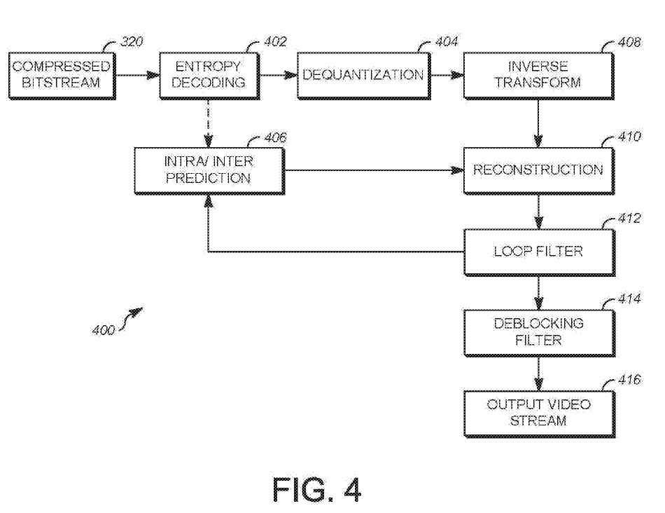

FIG. 4 is a block diagram of a decoder 400 in accordance with implementations of this disclosure. The decoder 400 can be implemented, for example, in the receiving station 110, such as by providing a computer software program stored in memory for example. The computer software program can include machine instructions that, when executed by the CPU 112, cause the receiving station 110 to decode video data in the manner described in FIG. 4. The decoder 400 can also be implemented as specialized hardware or firmware in, for example, the transmitting station 102 or the receiving station 110.

The decoder 400, similar to the reconstruction path of the encoder 300 discussed above, includes in one example the following stages to perform various functions to produce an output video stream 416 from the compressed bitstream 320: an entropy decoding stage 402, a dequantization stage 404, an inverse transform stage 408, an intra/inter prediction stage 406, a reconstruction stage 410, a loop filtering stage 412, and a deblocking filtering stage 414. Other structural variations of the decoder 400 can be used to decode the compressed bitstream 320.

When the compressed bitstream 320 is presented for decoding, the data elements within the compressed bitstream 320 can be decoded by the entropy decoding stage 402 (using, for example, arithmetic coding) to produce a set of quantized transform coefficients. The dequantization stage 404 dequantizes the quantized transform coefficients and the inverse transform stage 408 inverse transforms the dequantized transform coefficients to produce a derivative residual that can be identical to that created by the inverse transform stage 314 in the encoder 300. Using header information decoded from the compressed bitstream 320, the decoder 400 can use intra/inter prediction stage 406 to create the same prediction block as was created in the encoder 300, e.g., at the intra/inter prediction stage 304. In the case of inter prediction, the reference frame from which the prediction block is generated may be transmitted in the bitstream or constructed by the decoder using information contained within the bitstream.

At the reconstruction stage 410, the prediction block can be added to the derivative residual to create a reconstructed block that can be identical to the block created by the reconstruction stage 316 in the encoder 300. In some implementations, the loop filtering stage 412 can be applied to the reconstructed block to reduce blocking artifacts. The deblocking filtering stage 414 can be applied to the reconstructed block to reduce blocking distortion, and the result is output as the output video stream 416. The output video stream 416 can also be referred to as a decoded video stream and the terms will be used interchangeably herein.

Other variations of the decoder 400 can be used to decode the compressed bitstream 320. For example, the decoder 400 can produce the output video stream 416 without the deblocking filtering stage 414.

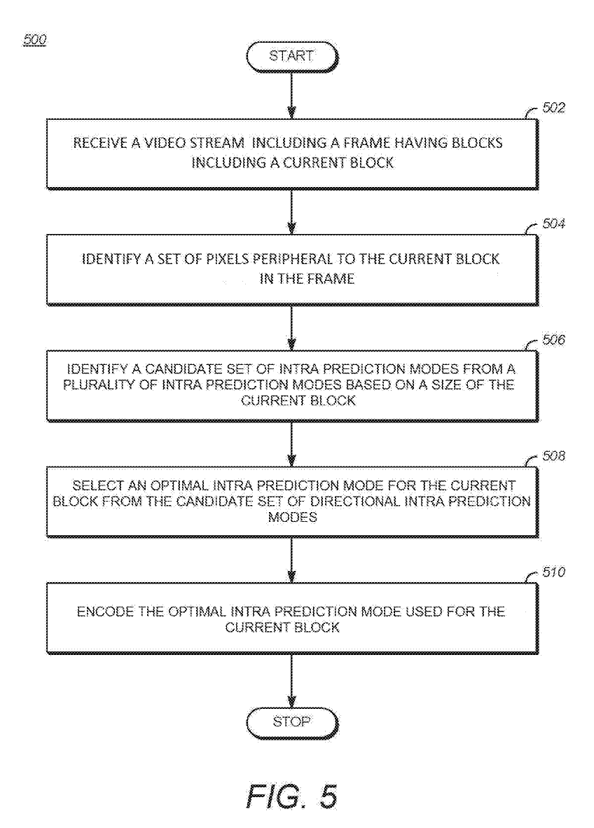

FIG. 5 is a flow diagram showing a process 500 for encoding a video stream using directional intra prediction modes in accordance with an implementation of this disclosure. The process 500 can be implemented in an encoder such as the encoder 300 (shown in FIG. 3) and can be implemented, for example, as a software program that can be executed by computing devices such as the transmitting station 102 or the receiving station 110 (shown in FIG. 1). For example, the software program can include machine-readable instructions that can be stored in a memory such as the memory 106 or the memory 114, and that can be executed by a processor, such as the CPU 104, to cause the computing device to perform the process 500.

The process 500 can be implemented using specialized hardware or firmware. Some computing devices can have multiple memories, multiple processors, or both. The steps of the process 500 can be distributed using different processors, memories, or both. Use of the terms “processor” or “memory” in the singular encompasses computing devices that have one processor or one memory as well as devices that have multiple processors or multiple memories that can each be used in the performance of some or all of the recited steps. For simplicity of explanation, the process 500 is depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

The process 500 assumes that a stream of video data having multiple frames, each having multiple blocks, is being encoded using a video encoder such as the encoder 300 executing on a computing device such as the transmitting station 102. The video data or stream can be received by the computing device in any number of ways, such as by receiving the video data over a network, over a cable, or by reading the video data from a primary memory or other storage device, including a disk drive or removable media such as a CompactFlash (CF) card, Secure Digital (SD) card, or any other device capable of communicating video data. In some implementations, video data can be received from a video camera connected to the computing device operating the encoder. At least some of the blocks within frames are encoded using intra prediction as described in more detail below.

At 502, a video stream including a frame having multiple blocks of video data including a current block can be received by a computing device, such as the transmitting station 102. At 504, the process 500 identifies a set of pixels peripheral to the current block from the frame. By identify, this disclosure means distinguish, determine, select, or otherwise identify in any manner whatsoever. The set of pixels can include pixels from previously coded blocks in the frame. For example, the set of pixels can be identified from a block above, to the left, or to the above-left of the current block in the frame. The set of pixels can be, for example, a set of reconstructed pixels determined using the reconstruction path in FIG. 3 at the encoder 300.

The set of pixels can be identified from a single block, or multiple blocks peripheral to the current block. In some implementations, the set of pixels can include one or more rows of pixel values above the current block, or one or more columns of pixel values to the left of the current block, or a pixel from a block to the top-left of the current block, or any combination thereof. In other implementations, data from rows or columns not immediately adjacent to the current block, including data from blocks that are not adjacent to the current block, can be included in the set of pixels.

At 506, based on a size of the current block, the process 500 identifies a candidate set of directional intra prediction modes from a plurality of directional intra prediction modes that may be used to predict the current block.

As mentioned briefly above, directional intra prediction can be used to form prediction blocks by propagating pixels peripheral to the current block along an angular direction, that is, in a direction offset from both the horizontal and the vertical, to form a prediction block. The prediction block is then subtracted from the original block to form the residual. In directional intra prediction (also called angular intra prediction), the current block can be predicted by projecting reference pixels from neighboring blocks, typically on the left and top boundaries of the current block, in a certain angle or direction offset from the horizontal and the vertical lines. The reference pixels can be, for example, actual pixel values of the peripheral pixels or average pixel values (such as a weighted average) of the peripheral pixels. For example, some example directional intra prediction modes can include propagating the reference pixel values along directions such as 45 degree lines (“45 degree intra prediction mode”), 63 degree lines (“63 degree intra prediction mode”), 117 degree lines (“117 degree intra prediction mode”), 135 degree lines (“135 degree intra prediction mode”), 153 degree lines (“153 degree intra prediction mode”), 207 degree lines (“207 degree intra prediction mode”), etc., to form the prediction block.

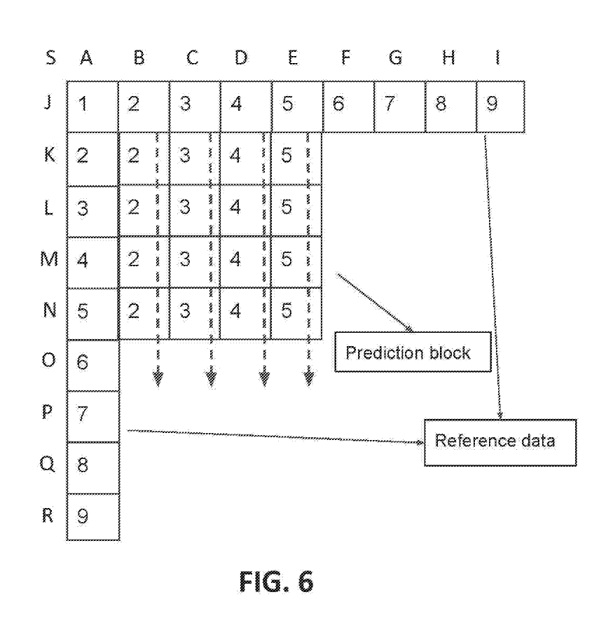

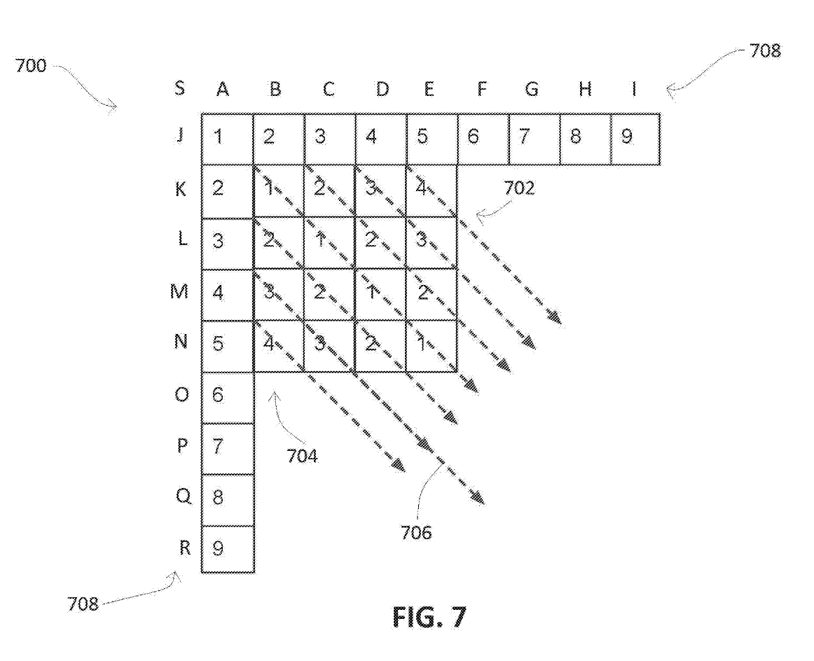

FIGS. 6 and 7 illustrate some example intra prediction modes including a vertical intra prediction mode and a 135 degree intra prediction mode. FIG. 6 is a diagram that illustrates a 90 degree (vertical) intra prediction mode, which propagates peripheral pixels A through E down the columns of the prediction block such that each pixel in a column has its value set equal to that of the adjacent peripheral pixel A through E in the direction of the arrows. FIG. 7 is a diagram that illustrates a 135 degree intra prediction mode, which propagates peripheral pixel values along 135 degree line (e.g., lines 706) to the right and down through the prediction block. The peripheral pixel values can include, for example, reference data 708 provided by peripheral pixels A through S from blocks adjacent to a 4×4 block of a frame 700 to be encoded, which can be used to form a prediction block 702 for the 4×4 block.

Although the 135 degree intra prediction mode in FIG. 7 is illustrated using the pixel values of the reference data 708 to generate the prediction block 702, in this example, a linear combination (e.g., weighted average) of two or three of the peripheral pixels can be used to predict pixel values of the prediction block along lines extending through the block. For example, the pixel value 704 to be propagated along line 706 can be formed from a weighted average of pixel values L, M, and N when another angular intra prediction mode is used.

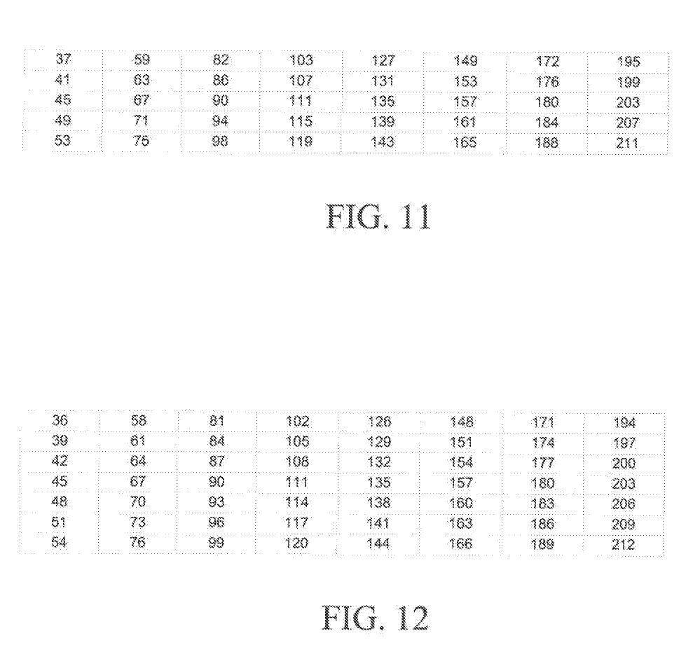

In some implementations, the plurality of directional intra prediction modes can include, for example, angular intra prediction modes using angles (in degrees) shown in FIGS. 11 and 12. For example, FIG. 11 shows 40 angles (in degrees) that can be used as directional intra prediction modes, and FIG. 12 shows another 56 angles (in degrees) that can be used as directional intra prediction modes.

Referring back to 506 of FIG. 5, the process 500 identifies a candidate set (subset) of directional intra prediction modes from the plurality of directional intra prediction modes based on the size of the current block. The number of directional intra prediction modes in the candidate set of directional intra prediction modes is variable and adaptive to the size of the current block. Typically, when the number of angles is not unnecessarily large, the more angles the encoder supports, the better the compression performance. However, the more angles the encoder supports, the slower the encoding speed.

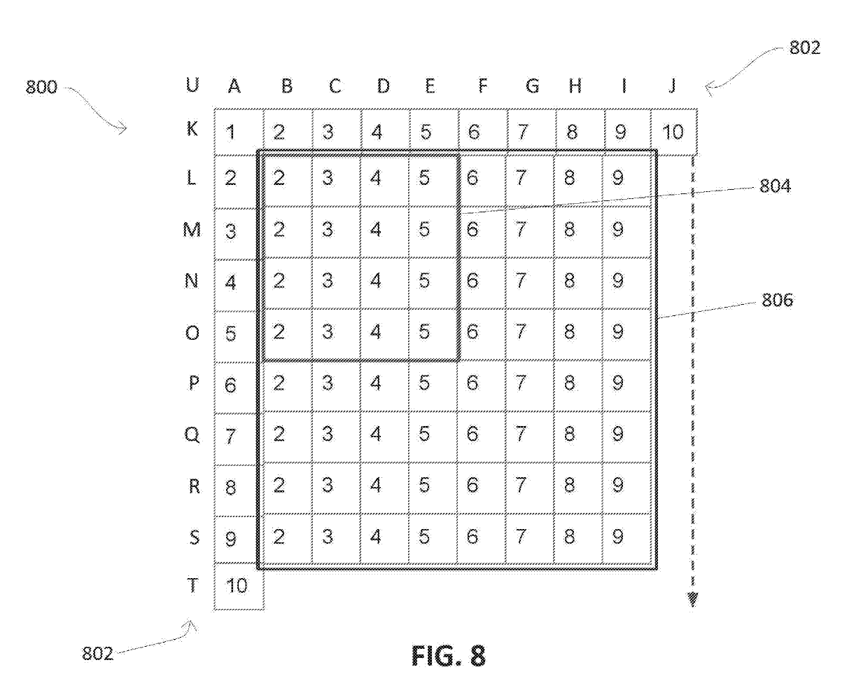

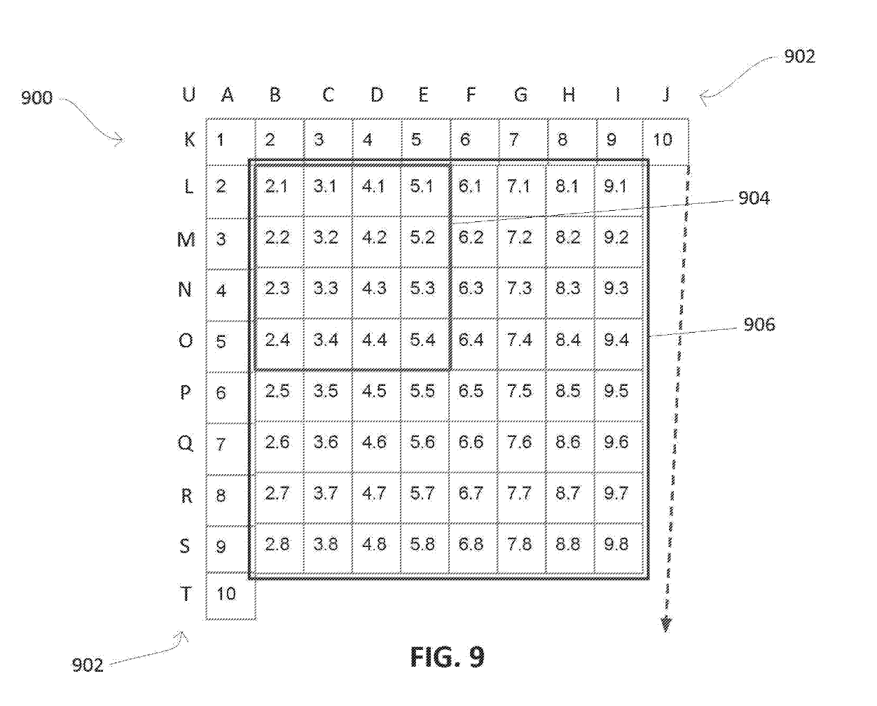

The difference between predictions using different angles is often less significant for smaller prediction blocks than for larger prediction blocks. For example, FIG. 8 is a diagram that illustrates a 90 degree (vertical) intra prediction mode for a 4×4 block resulting in prediction block 804 and for an 8×8 block resulting in a prediction block 806 using reconstructed values 802 of a frame 800, and FIG. 9 is a diagram that illustrates an 84 degree intra prediction mode for a 4×4 block resulting in a prediction block 904 and for an 8×8 block resulting in a prediction block 906 using reconstructed values 902 of a frame 900. The root mean square difference between the predicted values of the 4×4 prediction block 904 using the 84 degree intra prediction mode and the 4×4 block prediction 804 using the vertical intra prediction mode is 0.32. The root mean square difference between the predicted values for the 8×8 prediction block 906 using the 84 degree intra prediction mode and the 8×8 prediction block 806 using the vertical intra prediction mode in this illustrated example is 0.50. As can be seen from this example, the difference between predictions between the 84 degree angle and the 90 degree angle is less significant for 4×4 blocks than for 8×8 blocks.

Therefore, to improve the quality of prediction of larger blocks, more angles can be considered by the current block as candidate intra prediction modes. For smaller blocks, fewer angles can be considered so that the encoder can be substantially faster without sacrificing much compression efficiency. Overall, using a variable subset of directional intra prediction modes as the candidate set of directional intra prediction modes can reduce the number of directional intra prediction modes considered for smaller prediction blocks, which increases the encoding speed, and improves overall compression performance. By reducing the number of bits used to signal the prediction angle used, further optimization and bandwidth efficiency can be achieved.

The number of directional intra prediction modes in the candidate set of directional intra prediction modes can include a predetermined number of angles for the particular size of the current block, and the angles can be approximately evenly distributed between, for example, 0 degrees and 270 degrees. The number of angles for the candidate set of directional intra prediction modes can also be reduced by grouping angles that are close together.

In some implementations, a lookup table can be constructed for the size of the block to be predicted using, for example, a predetermined number of approximately evenly spaced angles as entries in the lookup table. For example, FIG. 11 illustrates an example implementation of a lookup table for blocks of size 4×4 and 8×8, where the lookup table includes 40 angles (in degrees) that are identified for 4×4 and 8×8 blocks, which correspond to 40 directional intra prediction modes in the candidate set of intra prediction modes identified for 4×4 and 8×8 blocks. FIG. 12 illustrates an example implementation of a lookup table for blocks of size 16×16, 32×32, and larger, where the lookup table includes 56 angles (in degrees) that are identified for 16×16, 32×32, and larger blocks, which correspond to 56 directional intra prediction modes in the candidate set of intra prediction modes identified for 16×16, 32×32, and larger blocks.

In other implementations, it is possible that the angles are not approximately evenly spaced as shown in the examples of FIGS. 11 and 12. In addition, the number of angles for each block size does not have to be predetermined and can be dynamically adjusted, and signaled to the decoder.

Returning to FIG. 5, process 500 selects, for the current block using a processor, an optimal intra prediction mode from the candidate set of directional intra prediction modes at 508. The optimal intra prediction mode is used to predict the current block based on the set of previously coded pixels. For example, an optimal directional intra prediction mode can be selected to predict the current block by testing each directional intra prediction mode in the candidate set of directional intra prediction modes using the set of previously coded pixels to predict the current block, and selecting the directional intra prediction mode that provides the best compression (e.g., fewest bits, including bits required to specify the intra prediction mode in the encoded video bitstream) with the least distortion (that is, the least amount of error in the predicted and subsequently reconstructed block). The selection process can occur in a rate distortion loop. In cases where the blocks are better predicted by inter prediction, the best inter prediction mode can be selected as the optimal prediction mode for the current block.

Referring to FIGS. 11 and 12 as examples of the processing at 508, the optimal intra prediction mode can be selected from, for example, a candidate set of directional intra prediction modes shown in FIG. 11, when the current block is a 4×4 block or an 8×8 block. For example, the optimal intra prediction mode can be selected as a 94 degree directional intra prediction mode. When the current blocks is 16×16 block or larger, the optimal intra prediction mode can be selected from, for example, a candidate set of directional intra prediction modes shown in FIG. 12. For example, optimal intra prediction mode can be selected as a 93 degree directional intra prediction mode. In some implementations, some of the directional intra prediction modes that have close angular values can be grouped together, or combined into one directional intra prediction mode. For example, in some implementations, a 93 degree directional intra prediction mode can be combined with a 94 degree directional intra prediction mode. The angular values that are grouped together can come from, for example, same or different candidate sets. As discussed above, the optimal intra prediction mode can be selected in a rate distortion loop that identifies a prediction mode resulting in an optimal rate distortion value.

At 510, the process 500 encodes the optimal directional intra prediction mode used for the current block before processing begins again for the next block of the current frame. In addition, the current block can be encoded according to the process described with respect to FIG. 3.

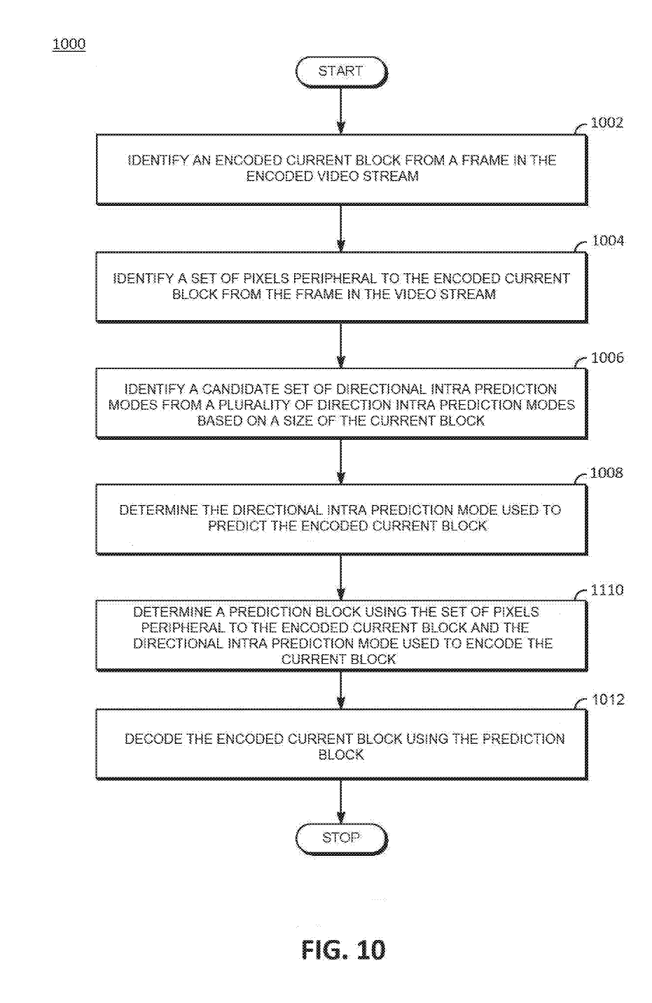

FIG. 10 is a flow diagram of a process 1000 for decoding an encoded video stream using directional intra prediction modes in accordance with implementations of this disclosure. The decoder can identify the particular directional intra prediction mode that was selected in the process 500, shown in FIG. 5, to encode a block. The decoder can read the index of the bitstream to determine the particular directional intra prediction mode to use from a plurality of directional intra prediction modes. The process 1000 can be implemented, for example, as a software program that may be executed by computing devices such as the transmitting station 102 or the receiving station 110. For example, the software program can include machine-readable instructions that may be stored in a memory such as the memory 106 or the memory 114, and that, when executed by a processor, such as the CPU 104 or the CPU 112, may cause the computing device to perform the process 1000. The process 1000 can be implemented using specialized hardware or firmware. As explained above, some computing devices may have multiple memories or processors, and the steps of the process 1000 can be distributed using multiple processors, memories, or both.

For simplicity of explanation, the process 1000 is depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

Desirably, the process 1000 substantially conforms to the process 500. There are some differences, however, that are pointed out in the following description of the process 1000. Where steps are substantially similar to those in the process 500, reference will be made to the description above.

A computing device such as the receiving station 110 may receive the encoded video stream, such as the compressed bitstream 320. The encoded video stream (which may be referred to herein as the encoded video data) can be received in any number of ways, such as by receiving the video data over a network, over a cable, or by reading the video data from a primary memory or other storage device, including a disk drive or a removable media such as a DVD, CompactFlash (CF) card, Secure Digital (SD) card, or any other device capable of communicating a video stream.

At 1002, an encoded current block can be identified from a frame in the encoded video stream. The encoded current block can be, for example, a block that has been encoded at the encoder 300 using any of the directional intra prediction modes described herein, such as the 90 degree (vertical) intra prediction mode of FIG. 6 or the 135 degree intra prediction mode of FIG. 7, or any of the angular intra prediction modes, such as those shown in FIGS. 11 and 12.

At 1004, the process 1000 identifies a set of pixels peripheral to the encoded current block from the frame in the video stream. The set of pixels can include pixels from previously decoded blocks in the frame, such as a block from the same frame as the current block that has been decoded prior to the current block. For example, the set of pixels can be identified from a block above, a block to the left, or a block to the above-left of the current block in the same frame. The set of pixels can be identified from a single block in the frame, or multiple blocks peripheral to the current block in the same frame. For example, the set of pixels can include pixels from multiple blocks, such as blocks to the left of the current block, blocks above the current block, and/or blocks to the above-left of the current block.

In some implementations, the set of pixels can include one or more rows of pixel values above the current block, or one or more columns of pixel values to the left of the current block, or one or more columns of pixel values to the above-left of the current block, or any combination thereof. For example, the set of pixels can include one of a column of pixels from the block to the left of the current block, a row of pixels from a block above the current block, a pixel from a block to the top-left of the current block, or any combination thereof. In other implementations, data from rows or columns not immediately adjacent to the current block, including data from blocks that are not adjacent to the current block, can be included in the set of pixels.

At 1006, the process 1000 identifies a candidate set of directional intra prediction modes from a plurality of directional intra prediction modes based on a size of the current block. Similar to the processing at 506, the number of directional intra prediction modes in the candidate set of directional intra prediction modes can be variable and adaptive to the size of the current block.

At 1008, the process 1000 determines the directional intra prediction mode used to predict the encoded current block. The directional intra prediction mode can be previously selected from the candidate set of directional intra prediction modes at 508, and used to predict the current block during the encoding process based on the set of previously coded pixels. The directional intra prediction mode can be determined at least partially by, for example, reading bits from one or more headers such as a header associated with the current block or a frame header. This information can be communicated by reading and decoding bits from the encoded video stream that indicate to the decoder the use of a directional intra prediction mode and information about the directional intra prediction mode (e.g., index or some other indication) according to one of the techniques disclosed above. Using the candidate set of directional intra prediction modes identified at 1006 and the decoded information regarding the directional intra prediction mode, the directional intra prediction mode can be determined. However, when the direction or angle can be decoded directly from the information about the directional intra prediction mode in the encoded bitstream, the candidate set of directional intra prediction modes is not necessary.

At 1010, the process 1000 determines a prediction block using the set of pixels identified at 1004 and the particular directional intra prediction mode used to encode the current block. The process 1000 generally forms the prediction block by propagating the set of pixels along the angular direction of the particular directional intra prediction mode identified at 1008. At 1012, the encoded current block can be decoded using the prediction block. For example, the encoded current block can be entropy decoded at the entropy decoding stage 402, dequantized at the dequantization stage 404, and inverse transformed at the inverse transform stage 408 to determine the derivative residual. The derivative residual can be added to the prediction block determined for the current block at 1010 to reconstruct the current block at the reconstruction stage 410. A frame can be reconstructed from the reconstructed blocks and the output can be an output video stream, such as the output video stream 416 shown in FIG. 4, and may be referred to as a decoded video stream.

The aspects of encoding and decoding described above illustrate some exemplary encoding and decoding techniques. However, it is to be understood that encoding and decoding, as those terms are used in the claims, could mean compression, decompression, transformation, or any other processing or change of data.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 110 (and the algorithms, methods, instructions, etc., stored thereon and/or executed thereby, including by the encoder 300 and the decoder 400) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 110 do not necessarily have to be implemented in the same manner.

Further, in one aspect, for example, the transmitting station 102 or the receiving station 110 can be implemented using a general purpose computer or general purpose processor with a computer program that, when executed, carries out any of the respective methods, algorithms and/or instructions described herein. In addition or alternatively, for example, a special purpose computer/processor can be utilized that contains other hardware for carrying out any of the methods, algorithms, or instructions described herein.

The transmitting station 102 and the receiving station 110 can, for example, be implemented on computers in a video conferencing system. Alternatively, the transmitting station 102 can be implemented on a server and the receiving station 110 can be implemented on a device separate from the server, such as a hand-held communications device. In this instance, the transmitting station 102 can encode content using an encoder into an encoded video signal and transmit the encoded video signal to the communications device. In turn, the communications device can then decode the encoded video signal using a decoder. Alternatively, the communications device can decode content stored locally on the communications device, for example, content that was not transmitted by the transmitting station 102. Other suitable implementation schemes of the transmitting station 102 and the receiving station 110 are available. For example, the receiving station 110 can be a generally stationary personal computer rather than a portable communications device and/or a device including the encoder 300 may also include the decoder 400.

Further, all or a portion of implementations of the present disclosure can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available. The above-described embodiments, implementations and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

1. A method for encoding a video stream, comprising:
identifying, peripheral to a current block of a frame of the video stream, a set of previously coded pixels in the frame;
identifying a candidate set of directional intra prediction modes from a plurality of directional intra prediction modes based on a size of the current block; and
selecting, for the current block using a processor, an optimal intra prediction mode from the candidate set of directional intra prediction modes, wherein the optimal intra prediction mode is used to predict the current block based on the set of previously coded pixels.

2. The method of claim 1, wherein each of the plurality of directional intra prediction modes is associated with a defined angle for predicting the current block along a direction specified by the defined angle using the set of previously coded pixels.

3. The method of claim 2, further comprising:
storing the defined angles in a lookup table the size of the current block.

4. The method of claim 1, wherein a number of the directional intra prediction modes in the candidate set of directional intra prediction modes varies based on the size of the current block.

5. The method of claim 4, wherein the candidate set of directional intra prediction modes comprises a first candidate set of directional intra prediction modes comprising a first number of the directional intra prediction modes when the size of the current block is the first size, and a second candidate set of directional intra prediction modes comprising a second number of the directional intra prediction modes when the size of the current block is a second size larger than the first size, the second number being larger than the first number.

6. The method of claim 1, wherein a first candidate set of directional intra prediction modes identified for a first block in the frame comprises a fewer number of directional intra prediction modes than a second candidate set of directional intra prediction modes identified for a second block in the frame, when a size of the first block is less than a size of the second block.

7. The method of claim 1, wherein selecting the optimal intra prediction mode:
selecting a directional intra prediction mode from the candidate set of directional intra prediction modes that results in a smallest rate-distortion cost.

8. The method of claim 1, further comprising:
identifying a subset of previously coded pixels from the set of previously coded pixels based on the optimal intra prediction mode; and
determining, for the current block, a prediction block using the subset of previously coded pixels.

9. A method for decoding a video stream, comprising:
identifying, at pixel positions peripheral to a current block of a frame of the video stream, a set of previously decoded pixels in the frame;
identifying a directional intra prediction mode previously selected for encoding the current block from a candidate set of directional intra prediction modes that is based on a size of the current block;
determining, using a processor, a prediction block using the directional intra prediction mode and the set of previously decoded pixels; and
decoding the current block using the prediction block.

10. The method of claim 9, wherein each of the directional intra prediction modes of the candidate set of directional intra prediction modes is associated with a respective angle for predicting the current block along a direction specified by the respective angle using the set of previously decoded pixels.

11. The method of claim 10, further comprising:
storing the candidate set of directional intra prediction modes in a lookup table for decoding the video stream.

12. The method of claim 9, wherein the candidate set of directional intra prediction modes varies based on the size of the current block.

13. The method of claim 12, wherein the candidate set of directional intra prediction modes comprises an increasing number of directional intra prediction modes as the size of the current block increases.

14. The method of claim 9, wherein a first candidate set of directional intra prediction modes identified for a first block in the frame comprises a fewer number of directional intra prediction modes than a second candidate set of directional intra prediction modes identified for a second block in the frame, when a size of the first block is less than a size of the second block.

15. (canceled)

16. (canceled)

17. (canceled)

18. (canceled)

19. (canceled)

20. (canceled)

21. An apparatus for decoding a video stream, comprising:
a memory; and
a processor configured to execute instructions stored in the memory to:
identify an intra prediction mode previously selected for encoding a current block of a frame from a first candidate set of directional intra prediction modes that is based on a size of the current block, the first candidate set of directional intra prediction modes being different from a second candidate set of directional intra prediction modes for a block having a size different from the current block;
determine a prediction block using the inter prediction mode and a set of previously decoded pixels peripheral to the current block; and
decode the current block using the prediction block.

22. The apparatus of claim 21, wherein:
the first candidate set has a first number of directional intra prediction modes;
the second candidate set has a second number of directional intra prediction modes that is higher than the first number when the size of the current block is smaller than the size different from the current block; and
the second candidate set has a second number of directional intra prediction modes that is lower than the first number when the size of the current block is larger than the size different from the current block.

23. The apparatus of claim 21, wherein each directional intra prediction mode in the first candidate set of directional intra prediction modes is different from each directional intra prediction mode in the second candidate set of directional intra prediction modes.

24. The apparatus of claim 21, wherein the processor is configured to execute instructions stored in the memory identify the set of previously decoded pixels peripheral to the current block.

25. The apparatus of claim 21, wherein each directional intra prediction mode in the first candidate set of directional intra prediction modes is associated with a respective angle for predicting the current block along a direction specified by the angle using the set of previously decoded pixels.

26. The apparatus of claim 25, wherein the processor is configured to execute instructions stored in the memory to:
identify the first candidate set of directional intra prediction modes from a lookup table based on the size of the current block.
